(19) United States
(12) Patent Application Publication
(10) Pub. No.: US 2026/0148555 A1
(43) Pub. Date: May 28, 2026

(54) Spatial Recall from Videos

(71) Applicant: Microsoft Technology Licensing, LLC, Redmond, WA (US)

(72) Inventors: Rui WANG, Wallisellen (CH); Ondrej MIKSIK, Dubendorf (CH); Enric Galceran YEBENES, Meilen (CH); Marc Andre Leon POLLEFEYS, Zurich (CH)

(73) Assignee: Microsoft Technology Licensing, LLC, Redmond, WA (US)

(21) Appl. No.: 18/959,860

(22) Filed: Nov. 26, 2024

(51) Int. Cl. G06V 20/40; G06T 7/70; G06V 10/77; G06V 10/82

(52) U.S. Cl. CPC G06V 20/46; G06T 7/70; G06V 10/7715; G06V 10/82

(57) ABSTRACT

A technique creates entries in a spatiotemporal data structure that describe objects and activities in videos captured by a plurality of cameras. For instance, each entry in the spatiotemporal data structure includes different kinds of embeddings associated with a particular video captured by a camera. Each entry is further associated with a particular pose in a three-dimensional map and a particular time. In some implementations, the different kinds of embeddings include text embeddings, audio embeddings, and action embeddings, all produced using a neural network (such as a multi-modal language model). Another technique interrogates the spatiotemporal data structure by: receiving a query; mapping the query into query embeddings using the neural network; finding a particular entry in the spatiotemporal data structure that matches the query embeddings; and retrieving information associated with the particular entry.

### BACKGROUND

Computing technology has recently been developed that records actions taken by a user during the user's interaction with user interface presentations provided by a computing device. This computing technology assists the user's interaction with the computing device, e.g., by assisting the user in recalling previous actions that the user has taken while interacting with the computing device.

### SUMMARY

According to illustrative aspects, a technique is described herein for creating a spatiotemporal data structure. The technique includes receiving plural videos captured in a physical environment using plural cameras, and creating entries in the spatiotemporal data structure that describe objects and activities in the videos. For instance, each entry in the spatiotemporal data structure includes different kinds of embeddings that describe at least part of a particular video captured by one of the cameras. Each entry is further associated with a particular pose in a three-dimensional map and a particular time.

According to another aspect, the process of producing embeddings uses a neural network and includes, for any given video: mapping image information that describes objects that appear in frames of the video into image embeddings; mapping text information that describes textual and/or audio content of the video into text embeddings; and mapping video segment information that describes actions exhibited by video segments of the video into action embeddings. The creation of each entry in the spatiotemporal data structure further includes computing poses (e.g., locations and orientations) of the camera that captured the video at different respective times during capture of the video, and computing the poses of the different objects and activities depicted in the video at the different respective times.

Another technique is described herein for interrogating the spatiotemporal data structure. This technique includes: receiving a query; mapping the query into query embeddings using the neural network; finding a particular entry in the spatiotemporal data structure that matches the query embeddings; and retrieving information associated with the particular entry.

Among other technical merits, the spatiotemporal data structure provides an efficient way of representing information expressed in the plurality of videos captured by the cameras. The above-summarized technology further assists a user in recalling actions that they have taken throughout the day in the physical environment, not limited to the user's actions in interacting with computing devices. This recall process is more time and resource efficient compared to an approach that involves manually recording and retrieving event information throughout the day in an ad hoc manner using different applications.

The above-summarized technology is capable of being manifested in various types of systems, devices, components, methods, computer-readable storage media, data structures, graphical user interface presentations, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF DRAWINGS

FIG. 1 shows a video-processing system for creating a spatiotemporal data structure based on videos captured in a physical environment, and then interacting with the spatiotemporal data structure.

FIG. 2 shows the association of different frames in a video with different activities and objects.

FIG. 3 shows one way to organize data in a spatiotemporal data structure.

FIG. 4 shows another way to organize data in a spatiotemporal data structure.

FIG. 5 shows components of the video-processing system of FIG. 1 that create a spatiotemporal data structure.

FIG. 6 shows one approach for linking pose information with embeddings, using the components of FIG. 5.

FIG. 7 shows a filtering mechanism for determining whether a newly created entry has a private or shared status, and storing the entry in a private or shared spatiotemporal data structure based on the assessed status.

FIG. 8 shows components of the video-processing system of FIG. 1 for interrogating the spatiotemporal data structure.

FIG. 9 shows an application that uses an extended reality system to present a graphical representation of a map based on a spatiotemporal data structure. The map is annotated with activities and objects that appear in videos.

FIG. 10 shows an application that involves controlling an autonomous agent based on the spatiotemporal data structure.

FIG. 11 shows one implementation of a multimodal language model used by the video-processing system of FIG. 1.

FIG. 12 shows further details regarding the multimodal language model of FIG. 11.

FIG. 13 is a flowchart that provides an overview of one approach for creating a spatiotemporal data structure.

FIG. 14 is a flowchart that provides an overview of one approach for interacting with the spatiotemporal data structure.

FIG. 15 shows computing equipment that, in some implementations, is used to implement the video-processing system of FIG. 1.

FIG. 16 shows an illustrative type of computing system that, in some implementations, is used to implement any aspect of the features shown in the foregoing drawings.

The same numbers are used throughout the disclosure and figures to reference like components and features.

### DETAILED DESCRIPTION

### A. Overview of the Video-Processing System

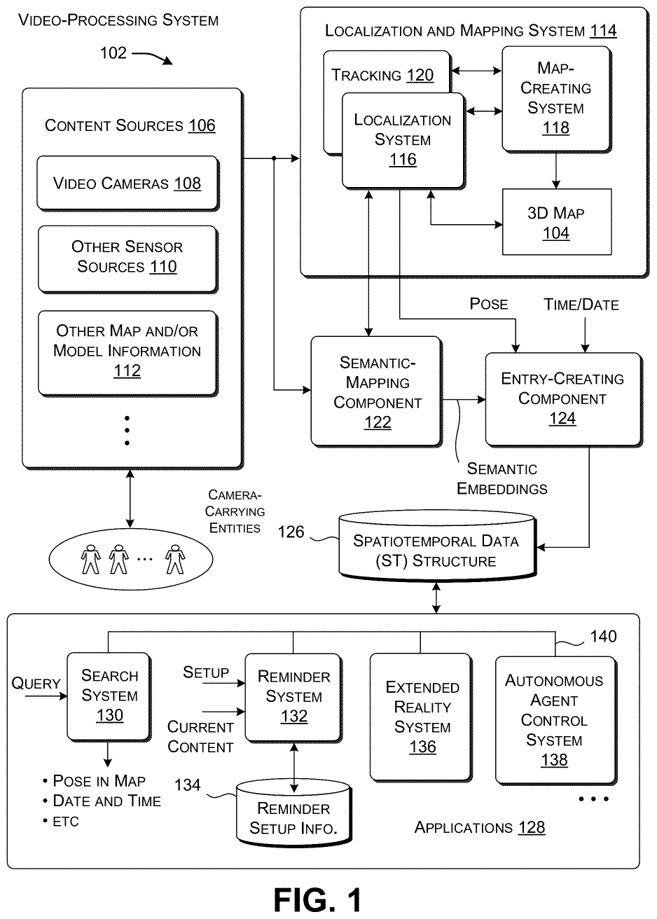

FIG. 1 shows a video-processing system 102 for creating a spatiotemporal data structure based on videos captured in a physical environment, and then interacting with the spatiotemporal data structure. The spatiotemporal data structure includes a plurality of entries. Each entry describes a group of embeddings that describe one or more objects and/or one or more actions depicted in a video at a particular time and at a particular pose. In some implementations, a pose refers to the position and orientation of the object or action with respect to a specified frame of reference. For example, each pose is expressed as a six-degree-of-freedom (6D) pose, which describes a 3D rotation and a 3D translation with respect to a frame of reference. In other implementations, a pose refers to just the position (location) of an object or action. The time refers to the time at which the object or action was captured by a camera. Further, the term “time” or “time information” encompasses any temporal-related information, including time of day, date, etc. In some implementations, a particular time also has a duration, such as a one-second time interval that commences at a particular starting time.

The physical environment represented by the spatiotemporal data structure is any indoor and/or outdoor space having any scope. Examples of physical environments include domestic homes, office buildings, manufacturing plants, campuses, parks, neighborhoods, etc. However, to facilitate description, the examples presented herein are principally framed in the context of the space defined by a single physical building used by a business.

The video-processing system 102 produces a three-dimensional (3D) map 104 based on information collected from one or more content sources 106. In some implementations, the content sources 106 include video cameras 108. Some of these video cameras 108 are worn or carried by users as the users traverse the physical environment. Examples of these types of video cameras are eyeglass-mounted video cameras, extended reality headsets, etc. “Extended reality” encompasses virtual reality technologies, augmented reality technologies, mixed reality technologies, etc. In addition, or alternatively, the video cameras 108 are agent-borne cameras. Example of these video cameras are cameras mounted to robots, cars, etc. which move about the physical environment. In addition, or alternatively, the video cameras 108 include cameras placed at fixed locations throughout the physical environment. Further note that, while this description focuses on the use the plural video cameras 108, the principles described herein can be implemented using a single video camera that moves about the physical environment.

In addition, or alternatively, some implementations of the video-processing system 102 rely on one or more other sensor sources 110 to produce the 3D map 104. These other sensor sources 110 include range-finding devices (e.g., Light Detecting and Ranging (LIDAR) devices), depth cameras (e.g., stereoscopic camera setups), odometers (e.g., wheel rotation encoders), Global Positioning System (GPS) systems, inertial measurement units (IMUs), dead-reckoning systems, and so on. In addition, or alternatively, some implementations of the video-processing system 102 rely on preexisting sources 112 of information, such as computer aided design (CAD) files that describe building layouts and/or three-dimensional models that describe the structures of objects.

A localization and mapping system 114 uses a localization system 116 working in conjunction with a mapping system 118 to create the 3D map 104. One approach for implementing this feature is the Simultaneous Localization and Mapping (SLAM) algorithm. Software for performing the SLAM technique is publicly available (e.g., from the GitHub website) from various sources, such as (1) ORB-SLAM, developed by University of Zaragoza, Zaragoza, Spain, and described in Mur-Artal, et al., “ORB-SLAM: A Versatile and Accurate Monocular SLAM System,” arXiv:1502.00956v2 [cs.RO], Sep. 18, 2015, 18 pages; (2) Maplab, developed by the Autonomous Systems Lab, ETH Z of Zurich, Switzerland, and described in Cramariuc, et al, “maplab 2.0—A Modular and Multi-Modal Mapping Framework, arXiv, arXiv:2212.00654v2 [cs.RO], Jan. 3, 2023, 8 pages; and (3) LDSO, described in Goa, et al., “LDSO: Direct Sparse Odometry with Loop Closure,” arXiv, arXiv:1808.01111v1 [cs.CV], Aug. 3, 2018, 7 pages. Background information on the general topic of the SLAM algorithm is available at Barros, et al., “A Comprehensive Survey of Visual SLAM Algorithms,” in Robotics, 2022, 28 pages, and at Kazerouni, et al., “A Survey of State-of-the-art on Visual SLAM,” in Expert Systems with Applications 205, 117734, June 2022, 23 pages. Some approaches to estimating state in SLAM apply an Extended Kalman Filter (EKF) or Particle Filter. Other SLAM algorithms use bundle adjustment, which is a minimization technique for refining the locations of the video cameras 108 and the points in the 3D map 104.

Other approaches to creating a 3D map include structure-from-motion (SfM) systems. Software for performing the SfM technique is publicly available (e.g., from the GitHub website) from OpenSfM developed by OpenMVG of San Diego, California. Background information on the general topic of SfM is provided by Ozyesil, et al., “A Survey of Structure from Motion,” arXiv, arXiv:1701.08493v2 [cs.CV], May 9, 2017, 40 pages.

The localization and mapping system 114 is principally directed to the task of determining the poses of stationary objects in the environment, such as walls, doors, and machines with fixed positions. In some implementations, the localization and mapping system 114 also uses a tracking component 120 to track the dynamic locations of objects in the physical environment. Software for performing tracking is publicly available (e.g., from the GitHub website) from various sources, such the ByteTrack system described in Zhang, et al., “ByteTrack: Multi-Object Tracking by Associating Every Detection Box,” arXiv, arXiv:2110.06864v3 [cs.CV], Apr. 7, 2022, 14 pages.

A semantic-mapping system 122 produces embeddings that represent information extracted from the videos. An embedding is a vector that represents information in a distributed fashion (as opposed to a one-hot vector that allocates separate dimensions for different concepts). More specifically, some implementations of the semantic-mapping system 122 use a multimodal language model to produce: a) image embeddings that represent information extracted from individual frames of the videos; b) text embeddings that represent text and/or audio content of the videos; and c) action embeddings that represent actions depicted in video segments of the videos. A video segment includes two or more successive frames. For example, the image embeddings represent objects and people in the physical environment. Text embeddings represent dialogue and/or textual captions in the videos. Action embeddings represent movements of human beings or inanimate entities in the physical environment. Other implementations incorporate the use of one or more other kinds of embeddings and/or omit one or more of the kinds of embeddings described above. Further note that the semantic mapping system 122 is capable of processing input information of a single media type, such as text information alone or image information alone.

An entry-creating component 124 creates the spatiotemporal data structure, which it stores a data store 126. As noted above, the spatiotemporal data anchors the embeddings produced by semantic mapping component 122 to pose information and time information.

Various applications 128 make use of the spatiotemporal data structure. For instance, a search system 130 maps a query submitted by a user or other entity into one or more query embeddings using the semantic mapping system 122. The search system 130 then finds one or more entries in the spatiotemporal data structure that match the query. The search system 130, for instance, responds to requests for information about prior activities performed by a user and/or one or more other individuals. A reminder system 132 determines whether an input video and/or other submitted content matches a previous-specified triggering condition. If so, the reminder system 132 generates and provides a notification. A data store 134 stores information regarding the triggering conditions that have been entered. An extended reality system 136 leverages the spatiotemporal data structure to present information to the user as the user traverses the physical environment. For example, the extended reality system 136 generates an augmented reality presentation that supplements a presentation of the actual physical environment (e.g., as viewed through an augmented reality headset) with information about prior activities and prior-observed objects identified in the spatiotemporal data structure. An autonomous agent control system 138 controls an autonomous agent based on information extracted from the spatiotemporal data structure. These applications are illustrative; other implementations include yet other uses of the spatiotemporal data structure. A connection 140 indicates that the reminder system 132, extended reality system 136, and autonomous agent control system 138 are capable of interacting with the search system 130 in performing their respective functions.

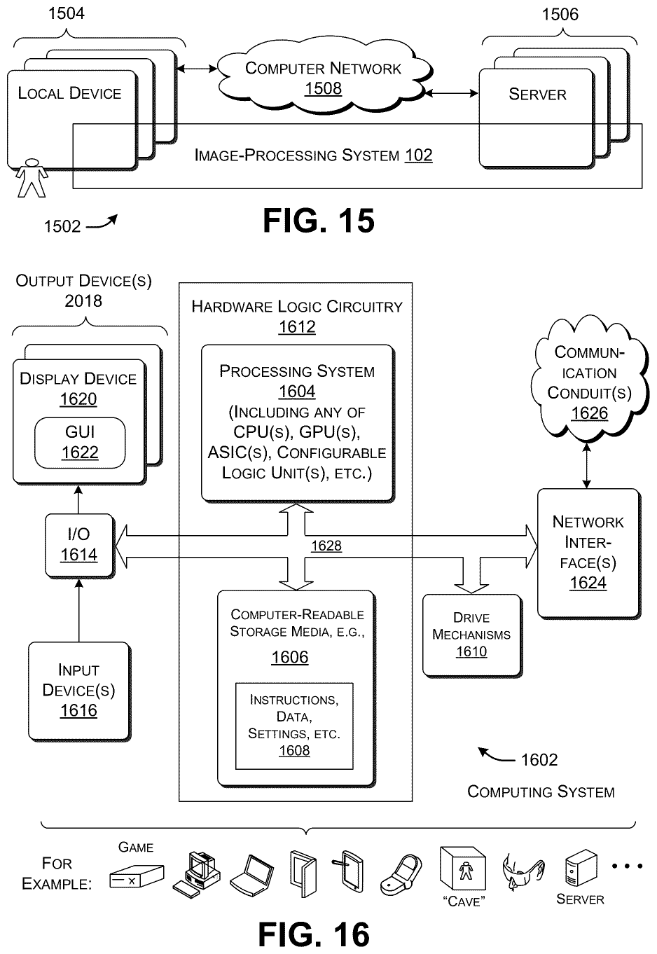

Additional information regarding each of the above functions appears in the sections below. The following terminology is relevant to some examples presented below. A “machine-trained model” or “model” refers to computer-implemented logic for executing a task using machine-trained weights that are produced in a training operation. A “weight” refers to any type of parameter value that is iteratively produced by the training operation. A “token” refers to a unit of information processed by a machine-trained model, such as a word or a part of a word. In some contexts, terms such as “component,” “module,” “engine,” and “tool” refer to parts of computer-based technology that perform respective functions. FIGS. 15 and 16, described below, provide examples of illustrative computing equipment for performing these functions.

As to the topic of privacy, the functionality described herein is capable of employing various mechanisms to ensure that any user data is handled in a manner that conforms to applicable laws, social norms, and the expectations and preferences of individual users. For example, the functionality is configurable to allow a user to expressly opt in to (and then expressly opt out of) the provisions of the functionality. The functionality is also configurable to provide suitable security mechanisms to ensure the privacy of the user data (such as data-sanitizing mechanisms, encryption mechanisms, and/or password-protection mechanisms), and to enable the user to control the storage and deletion of such data.

### B. Creating the Spatiotemporal Data Structure

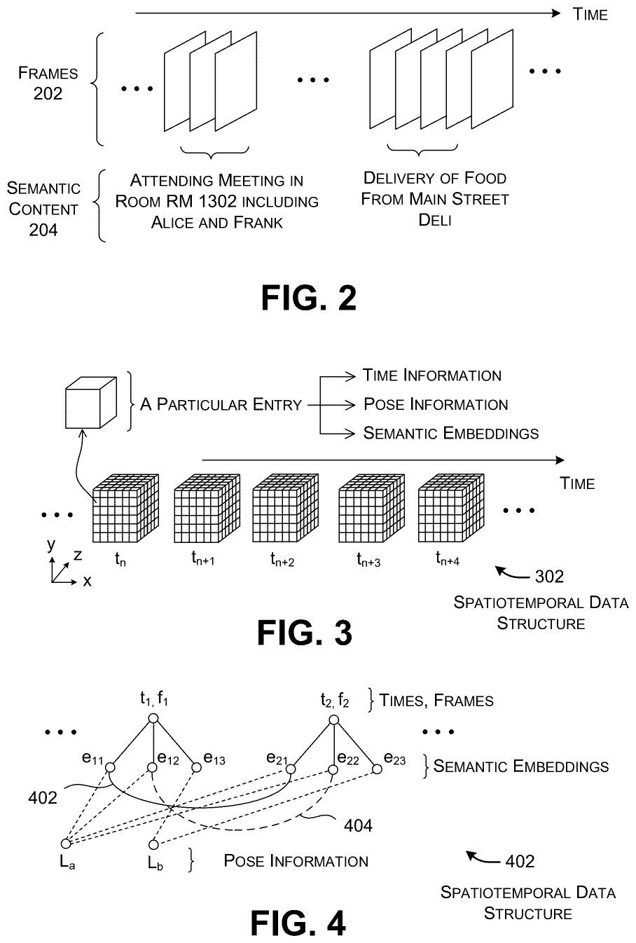

FIG. 2 shows the association of different frames 202 with different objects and activities, collectively referred to in FIG. 2 as semantic content 204. For example, two or more frames describe a meeting at a particular location that includes particular participants. Two or more frames describe the delivery of food. Each frame is associated with a particular time. Hence, each object or action which appears in a plurality of consecutive frames is implicitly performed over a prescribed span of time. Note that FIG. 2 is a simplified example; in actuality, any given frame may express any number of topics. In some examples, each frame expresses its content using RGB pixels produced by an RGB camera or RGBD information produced by an RGBD camera (where “D” represents depth).

Different implementations of the entry-creating component 124 use different kinds of organizational structures to represent pose, time and embedding information. FIGS. 3 and 4 show two such spatiotemporal data structures (302, 402) created by the entry-creating component 124. In the example of FIG. 3, the entry-creating component 124 discretizes the 3D map 104 of the physical environment into a plurality of cells, such 1×1 meter cells. Further, the entry-creating component 124 discretizes time into a plurality of time stamps. For instance, the time steps represent individual frames captured at particular times, or successive groupings of those frames (e.g., every 24 frames) associated with respective intervals of time (e.g., 1 second intervals); a single “time,” as used herein, encompasses either of these interpretations. The entry-creating component 124 associates embeddings captured at a particular time and at a particular location with a cell associated with this time and location, to produce the spatiotemporal data structure 302. FIG. 3 visualizes this kind of data structure 302 as a succession of instances of the spatially discretized 3D map 104, each instance being associated with a particular time step. In some implementations, the entry-creating component 124 then compresses the spatiotemporal data structure 302 by collapsing redundant entries into a single entry. For example, suppose that 200 frames of the video show a particular object and/or a particular activity that occurs in a specific volume of space. The entry-creating component collapses the cells associated with the object or event into a single cell, which it associates with a span of time, volume of space, and the particular object or activity.

In the example of FIG. 4, the entry-creating component 124 expresses the spatiotemporal data structure 402 as a graph data structure. The nodes of the graph data structure represent times, frames, poses, and embeddings. The links of the graph represent relationships among these entities. For instance, a pose node Lₐ denotes a pose (or just a location) that is associated with at least semantic embeddings e₁₁, e₁₂, e₂₁, and e₂₂. Links (402, 404) represent semantic relationships among the semantic embeddings. Further, each such embedding is associated with a time at which the object or activity was captured by a camera. An entry in this graphical data structure can be viewed as those nodes and links that are associated with a particular time and pose. This example more generally highlights the point that an “entry” refers to information that need not be collocated in a single memory location, but rather may represent information distributed over plural linked memory locations.

In either FIG. 3 or FIG. 4, in some implementations, each entry contains embeddings that originate from a part of a single video captured by a single camera at a single time, which describes an event at a single pose. In other implementations, a single entry contains contribution from two or more cameras for a single time and a single pose. This would be true for those cases in which two or more cameras simultaneously capture different aspects of a same event that takes place at the single time and a single pose. For example, an infrared camera may detect different aspects of the event than an RGB camera, or two RGB cameras may capture different aspects of the event based on their respective vantage points of capture. In these implementations, links associated with an entry can connect its embeddings to the frames of the videos from which they originate.

Other implementations use other information-logging strategies than those shown in FIGS. 3 and 4. For example, another implementation tags each embedding that is created with the pose and time information. An optional consolidating component can then consolidate any two or more entries that share a common embedding (within a prescribed tolerance) into a single entry. That single entry would identify the poses and times at which the common embedding was observed.

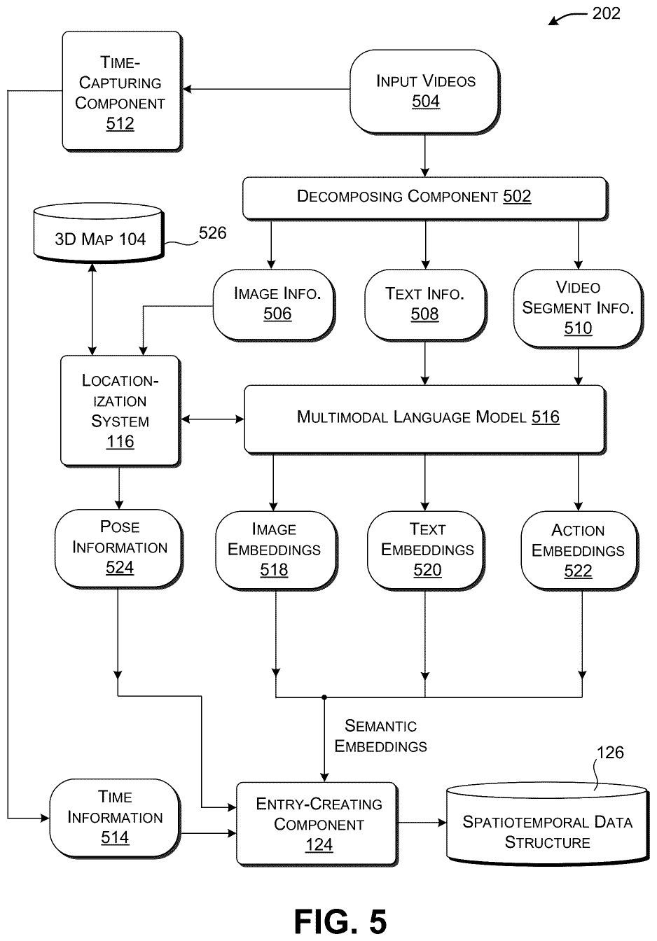

FIG. 5 shows components of the video-processing system 102 of FIG. 1 that create the spatiotemporal data structure. A decomposing component 502 decomposes one or more videos 504 into image information 506, text information 508, and video segment information 510. As noted above, the images of the image information 506 correspond to individual frames in the videos 504. The text information 508 represents textual content and/or audio content in the videos 504. The decomposing component 502 converts the audio content into text using a speech-to-text component (not shown). Each video segment in the video segment information 510 includes two or more of the frames. In a separate path, a time-capturing component 512 produces time information 514 that describes the times that the frames of the videos were captured. In some implementations, time-captured component 512 is a clock provided by each camera. In other examples, the time-capturing component 512 represents a mechanism for extracting time-related metadata from a video file.

A multimodal language model 516 maps the image information 506, text information 508, and video segment information 510 into respective kinds of embeddings (518, 520, 522). Section D describes a visual language model (VLM) that represents one implementation of the multimodal language model 516. The localization system 116 determines pose information 524 associated with each activity and object associated with an embedding, with reference to the 3D map 104 stored in a data store 526. Although not shown in FIG. 5, the video-processing system 102 also maintains links that associate each embedding with its originating frame(s), each of which is associated with a particular instance of time. The entry-creating component 124 assembles the embeddings (518, 520, 522), time information 514, and pose information 524 into a spatiotemporal data structure, which it stores in the data store 126.

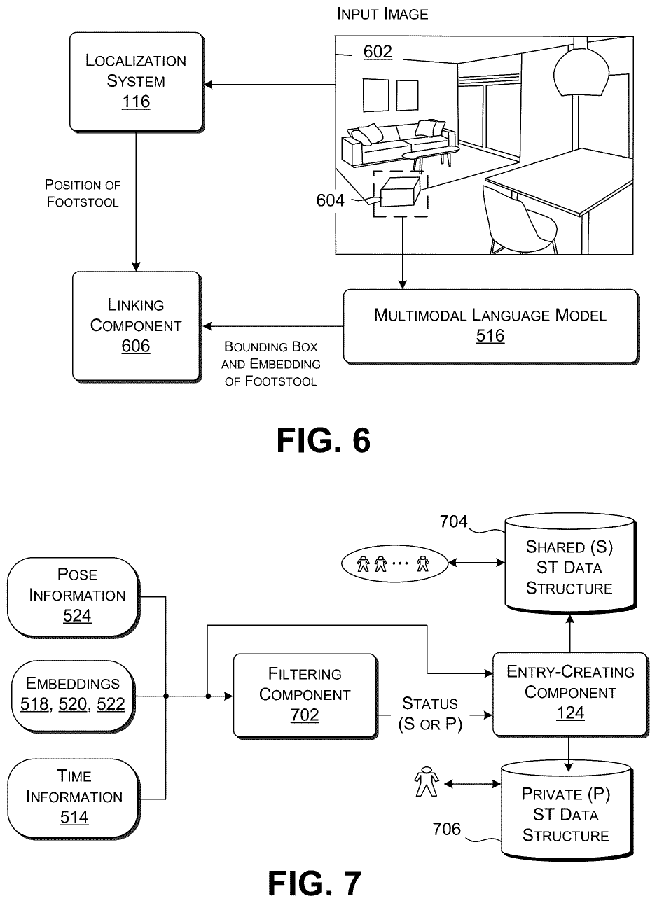

FIG. 6 shows one approach for linking the pose information 524 with the embeddings (518, 520, 522). The functionality of FIG. 6 is explained with reference to a particular frame 602 that depicts a footstool 604, among other objects. In the context of the SLAM algorithm, the localization system 116 determines a pose of a camera that captured the frame 602 in a world coordinate system. In some implementations, the localization system 116 uses triangulation to also determine the pose of each object and activity in a camera coordinate system, including the footstool 604. Triangulation is performed based on position information collected over plural views. Other approaches for determining the poses of the objects rely on depth camera measurements (if available), Structure-from-Motion (SfM) computations, template-matching techniques, feature-matching techniques, regression techniques, etc., or any combination thereof. General background on technology for determining the poses of objects can be found at: (1) Nejatishahidin, et al., “Review on 6D Object Pose Estimation with the focus on Indoor Scene Understanding,” arXiv, arXiv:2212.01920v1 [cs.CV], Dec. 4, 2022, 14 pages; (2) Guan, et al., “A Survey of 6DoF Object Pose Estimation Methods for Different Application Scenarios,” in Sensors 24, 1076, Feb. 7, 2024, 33 pages; and (3) Marullo, et al., “6D object position estimation from 2D images: a literature review,” in Multimedia Tools and Applications 82, Nov. 2022, pp. 24605-24643. The localization system 116 is able to produce the pose of each object in the world coordinate system by combining (e.g., multiplying) the pose of the object in the camera coordinate system with the pose of the camera in the world coordinate system. That is, consider a rigid-body transformation described by a 4×4 matrix T=[R, t; 0,1], where R is a 3×3 rotation matrix and t is a 3D translation vector. The localization system 116 computes the pose of an object in the world coordinate system using T_{object_world}=T_{object_camera}*T_{camera_world}, where T_{object_world} is the transformation matrix that describes the object's pose in the world coordinate system, T_{object_camera} is the transformation matrix that describes the object's pose in the camera coordinate system, and T_{camera_world} is the transformation matrix that describes the camera's pose in the world coordinate system.

In parallel therewith, the multimodal language model 516, or a dedicated object detection model (e.g., any model detection model in the YOLO family), performs object detection to determine a bounding box associated with the footstool 604 and one or more embeddings associated with the footstool. FIG. 6 represents the bounding box as a dashed-lined rectangle placed around the footstool 604. A linking component 606 associates the pose information produced by the localization system 116 with the footstool embedding(s) produced by the multimodal language model 516. In some implementations, this linking operation involves identifying the image elements (e.g., patches) associated with the bounding box produced by the multimodal language model 516, and consulting the localization system 116 to determine the pose information that is attributed to these same image elements.

FIG. 7 shows a filtering component 702 for discriminating whether a newly created entry has a private (P) or shared (S) status, and producing a label based on this conclusion. The entry-creating component 124 stores the entry in a shared data structure if it is assessed as shared. The entry-creating component 127 stores the entry in a private data structure if it is assessed as containing private data. Data stores (704, 706) store the shared and private data structures, respectively. The shared data structure is accessible to more people compared to the private data structure. For instance, the video-processing system 102 is available to anyone in a company, while the private data structure is available to a single individual or team within the company.

In some examples, the filtering component 702 is implemented as a machine-trained classification model of any type. The classification model maps information regarding an entry to its status. Examples of classification models include convolutional neural networks and transformer neural networks that include classification heads. In some implementations, a classification head includes one or more neural network layers followed by a Softmax operation. Alternatively, or in addition, the filtering component 702 consults discrete rules to determine the status of each entry.

In general, the spatiotemporal data structure provides a resource-efficient way of representing knowledge expressed in the plurality of videos captured by the cameras 108. The spatiotemporal data structure also enables a user to extract information about prior activities in a resource-efficient and time-efficient manner. These advantages can best be appreciated in contrast to a manual practice of logging and organizing events using plural applications. These separate applications are not integrated together. As a result, the information that these applications capture is likewise not integrated together. A user will expend considerable time and computing resources in interacting with these separate applications. Further, the user may find it challenging to reach cohesive and meaningful conclusions about past activities by consulting separate repositories of raw information.

### C. Applications of the Spatiotemporal Data Structure

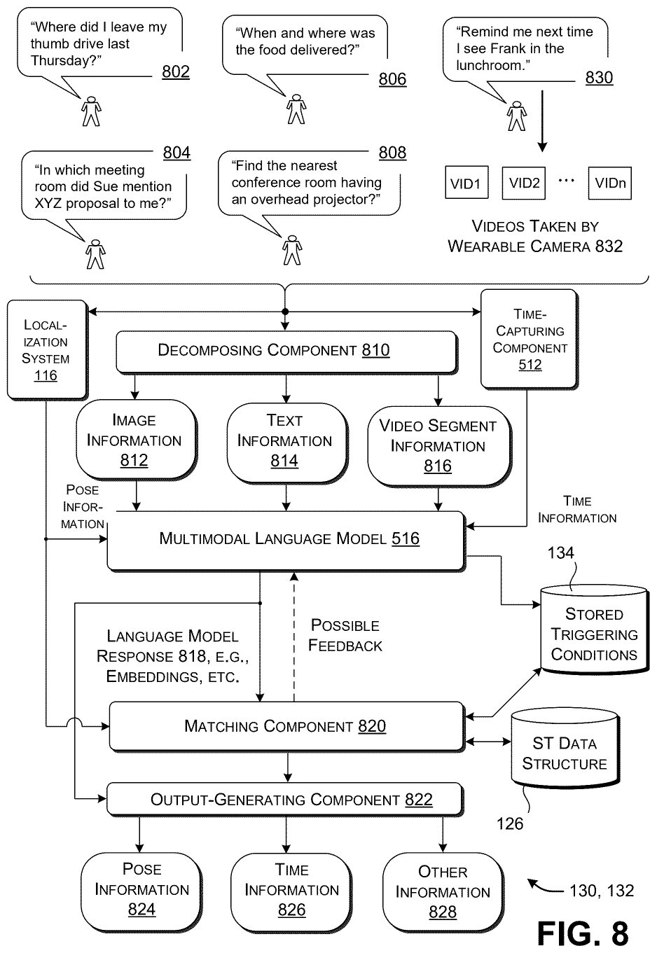

FIG. 8 shows one implementation of the search system 130. The search system 130 is able to process a variety of types of queries. A first type of query 802 asks the search system 130 to retrieve information about a user's prior activity. One example of the first type of query asks, “Where did I leave my thumb drive last Thursday?” A second query 804 asks the search system 130 to retrieve information regarding a user's prior activity, which the user performed with one or more other individuals. One example of this type of query asks, “In which meeting room did Sue mention XYZ proposal to me?” A third type of query 806 asks the search system 130 to retrieve an activity performed by others (and not the user who submitted the query). One example of this type of query asks, “When and where was the food delivered?” A fourth type of query 808 asks a question about a desired property of an object that has been observed by the video cameras 108. One example of this type of query asks, “Find the nearest conference room having an overhead projector.” The search system 130 maps each of these queries into query embeddings, and, if applicable, pose and time information, and then finds the entry (or entries) in the spatiotemporal data structure (in the data store 126) that are the closest matches to the query embeddings (and, if applicable, the pose and time information). Other queries (not shown) ask for objects and/or activities that include any combination of: content pertaining to a particular place; content pertaining to a particular time; content captured by a particular user; content captured by any user of a particular group of users; content captured by a particular camera; content having a particular privacy level; content having a particular frequency of recurrence, and so on.

With the above introduction, the functions shown in FIG. 8 will now be described. The queries can be expressed using any combination of media types, including text, images, videos. For example, the query 802 (“Where did I leave my thumb drive last Thursday?”) is entirely composed of text. Alternatively, or in addition, the person submitting the query provides an image and/or video that shows the act of leaving a thumb drive at a location, coupled with the prompt, “Tell me when and where I last performed the action described in this video <video>,” where “<video> is a reference to a file containing a video that shows the act of leaving a thumb drive.

A decomposing component 810 appropriately decomposes each query into its separate media parts. For example, with respect to a video, the decomposing component 810 decomposes the video into image information 812, text information 814, and video segment information 816. With respect to an input instance of text or audio, the decomposing component 810 produces only text information 814. With respect to an input image, the decomposing component 810 produces only image information 812 (although the decomposing component 810 can also provide text information if an image contains alphanumeric information).

If applicable, the localization system 116 determines pose information associated with any image or video that is part of the input query. For example, for a query that reads, “Tell me where I took this video,” the localization system 116 attempts to localize the contents of this video in the 3D map 104. The time-capturing component 512 also extracts any time information from the video that may be available.

The multimodal language model 516 maps the image information 812 to image embeddings, the text information 814 into text embeddings, and the video segment information 816 into action embeddings. In those examples in which a particular kind of media information is not provided, the multimodal language model 516 omits a corresponding instance of embeddings. The multimodal language model 516 then generates a response 818 that is based on these embeddings and/or any pose information and/or time information that is associated with the query.

A matching component 820 carries out instructions specified in the response 818 by matching the query with one or more entries in the spatiotemporal data structure. For instance, for some queries, the matching component 820 matches the set of query-derived embeddings with embeddings in the spatiotemporal data structure in the data store 126. For example, with respect to the query 806, “When and where was the food delivered?”, the matching component 820 finds an entry in the spatiotemporal data structure having embeddings that describes this occurrence. In addition, or alternatively, the matching component 820 takes into consideration pose information and/or time information and/or other metadata associated with the query in performing its matching function. For example, for the query, “Tell me whether the food was delivered here <video> last Thursday,” the matching component 820 also takes into consideration the location described in the accompanying video referenced by “<video>”.

An output-generating component 822 provides a response based on the results of matching. The response includes any combination of pose information 824, time information 826, and/or any other kind of information 828. For example, for the query, “What color shirt was I wearing last Tuesday?”, the matching component 820 extracts embeddings from the spatiotemporal data store that describe the shirt being referenced by the query. The search system 130 may then call the multimodal language model 516 again to convert the embeddings that describe the questioner's shirt to text, and to generate a response that reads: “The color of your shirt last Tuesday was navy blue.” The output-generating component 822 delivers this response.

The matching component 820 uses any strategy or combination of strategies to perform matching. For example, the matching component 820 is able to compare the similarity between two vectors (embeddings) using cosine similarity or any other distance metric. In some implementations, the matching component 820 uses a nearest neighbor search technique (e.g., approximate nearest neighbor (ANN)) to compare query embeddings with a large collection of embeddings in the spatiotemporal data structure. In addition, or alternatively, the matching component 820 is capable of performing lexical-type matching, e.g., by comparing pose information, time information, or other metadata associated with a query with alphanumeric information associated with a particular entry.

The reminder system 132 uses the infrastructure of the search system 130, and thus will also be explained with reference to FIG. 8. Referring to the top right part of FIG. 8, the reminder system 132 receives a two-part query. A first query part 830 specifies setup or configuration information, such as “Remind me next time I see Frank in the lunchroom.” A second query part 832 specifies a sequence of videos captured by a camera as the user moves about a physical environment. To execute a reminder task, the reminder system 132 dynamically detects whether each video that has been captured matches the triggering condition specified by the setup information. When this event is detected, the reminder system 132 generates a notification.

More specifically, the multimodal language model 516 produces embeddings and/or metadata associated with each triggering condition, and then stores this information in the data store 134. The multimodal language model 516 similarly converts each subsequent video to query embeddings (also referred to herein as other-video embeddings). In parallel therewith, the localization system 116 determines pose information for each video, and the time-capturing component 512 determines time information for each video. The matching component 820 determines whether the information extracted from each video (embeddings, pose information, time information, etc.) matches the information associated with a triggering condition previously stored in the data store 134. Note that this matching is performed independently of whether the spatiotemporal data structure stores an entry pertaining to a prior occasion identified in a triggering condition, e.g., in which the person Frank has been in the lunchroom. But the reminder system 132 is capable of using any such prior occasion (if it exists) to assist it in evaluating whether a current video shows the event under consideration (that is, whether the video indeed shows Frank in the lunchroom).

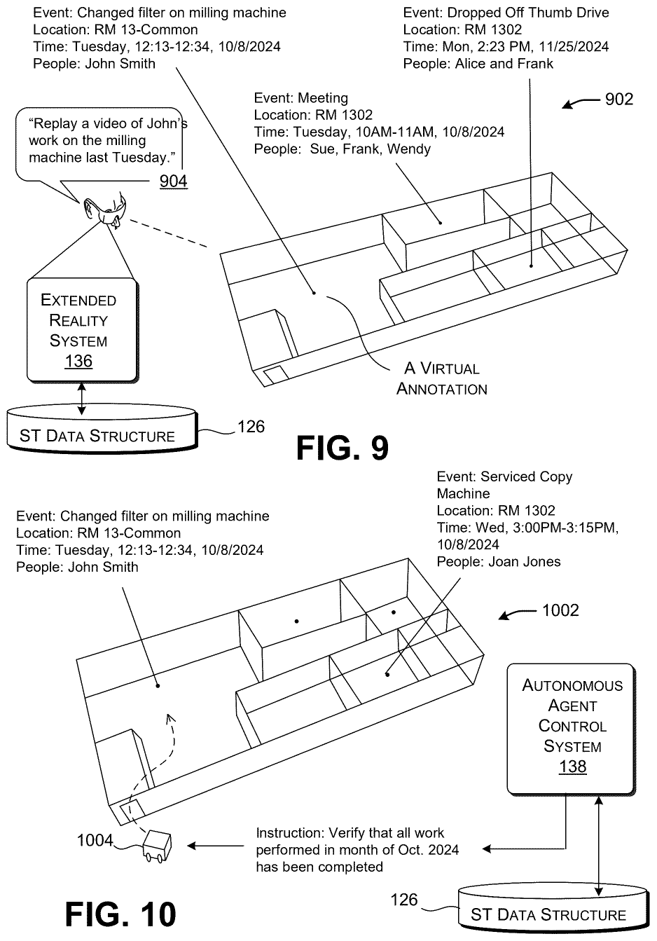

FIG. 9 shows an extended reality system 136 that incorporates the use of the spatiotemporal data structure. In the example of FIG. 9, the extended reality system 136 is an augmented reality system that presents virtual information extracted from the spatiotemporal data structure overlaid on a depiction of a physical environment 902. Here, the physical environment 902 is a workplace of any type, in which the user moves around wearing an augmented reality headset or carrying some other kind of augmented reality device.

In some implementations, the augmented reality system is configured to present visual markers regarding prior events when the user is directing his or her attention to a part of the physical environment 902 in which one or more prior events have occurred. To perform this function, the augmented reality system relies on the localization system 116 to determine the user's current location, which it performs by localizing the video content that is currently being captured by the user with respect to the 3D map 104. The augmented reality system also relies on any gaze detection mechanism to determine the direction of the user's attention (e.g., by tracking the user's head position and eye movements). The augmented reality system then uses the matching component 820 of the search system 130 to retrieve information regarding any events that have occurred at the part of the environment 902 under consideration. The augmented reality system produces a presentation that represents any such event, e.g., by overlaying text or other information on the part of the environment 902 that the user is looking at. Alternatively, or in addition, the augmented reality system replays a portion of the video on the basis of which the event was originally captured.

The augmented reality system is further capable of filtering the virtual information that it presents based on instructions from a user. For example, the augmented reality system may receive an instruction that specifies, “Annotate the map with markers that show the places I talked to Sally in the last 30 days.” In the specific example of FIG. 9, the user enters the query 904, “Replay a video of John's work on the milling machine last Tuesday.” In response to this query 904, the search system 130 finds an entry in the spatiotemporal data structure that matches this query 904. Assume that this entry is linked to the video being sought. The augmented reality system then replays the video while the user is looking at the milling machine. For instance, the augmented reality system overlays the video “on top” of a see-through or video-generated presentation of the actual milling machine or next to such a presentation of the actual milling machine. Other uses of this extended reality function apply the principles described above to a home environment. For example, the extended reality system 130 is capable of responding to a query that specifies: “When I am looking at the front yard, show me a video of my dog Spot catching a frisbee when he was a puppy,” or “When I am looking at the dinner table, show me what I had for dinner last night.”

The above-described examples are illustrative of a wide variety of other extended reality applications of the spatiotemporal data structure. For example, in another application, the extended reality system 136 provides virtual annotations that represent summaries or aggregates of plural events, e.g., in response to a query such as, “Identify the five locations in which I spent the most time in the last thirty days.” More generally, the extended reality system 136 is capable of successfully interpreting a request of any complexity based on analysis of that request performed by the multimodal language model 516.

FIG. 10 shows an autonomous agent control system 138 (“control system” for brevity) that controls an autonomous agent based on information extracted from the spatiotemporal data structure. Examples of autonomous agents include robots of various types and autonomous vehicles of various types. These autonomous agents are capable of moving around a physical environment 1002, but other autonomous agents perform control functions while remaining stationary in the physical environment 1002.

Like the extended reality system 136 of FIG. 9, the control system 138 performs at least some of its functions in cooperation with the search system 130. For example, FIG. 10 shows an occasion in which the autonomous agent sends an instruction to a robot 1004 that specifies: “Verify that all work performed in the month of Oct. 2024, has been completed.” This instruction constitutes a query. The search system 130 responds to the query by identifying entries in the spatiotemporal data structure that describe work performed in the specified timeframe. Each entry is associated with a particular location in the physical environment 1002. The control system 138 then directs the robot 1004 to travel to the identified locations and capture information at each of the locations.

The applications described in this section are representative of a wide variety of uses of the spatiotemporal data structure. Other implementations apply the spatiotemporal data structure to perform other tasks, including training, simulation, etc.

### D. Example of the Multimodal Language Model

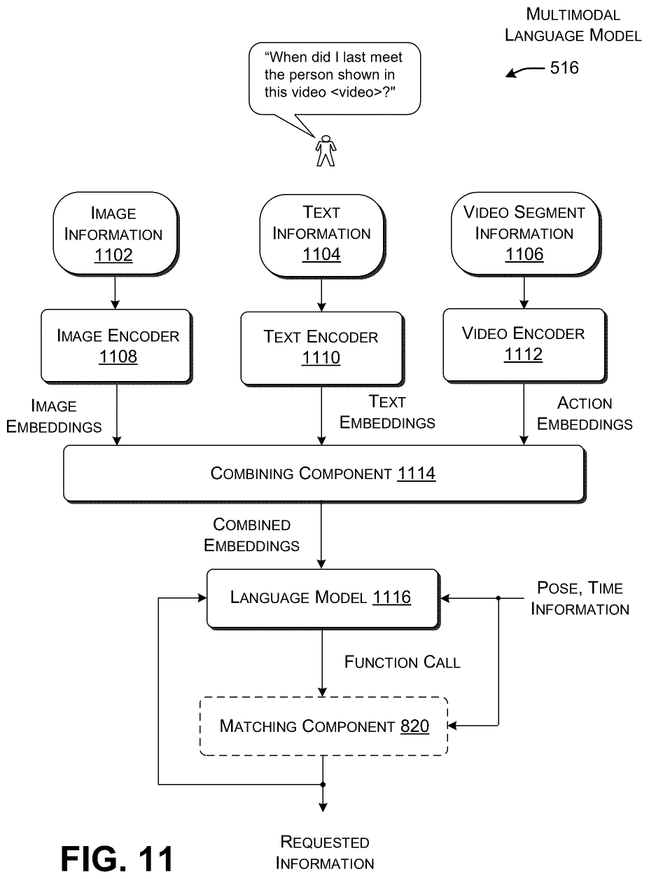

FIG. 11 shows one implementation of the multimodal language model 516, introduced in the context of FIG. 5. In this example, the multimodal model 516 is a visual language model (VLM) that operates on image information 1102, text information 1104, and video segment information 1106 that is produced, in some cases, by decomposing a video into separate media parts. The multimodal language model 516 includes plural encoders for mapping different instances of media information to corresponding embeddings. For instance, the different encoders include an image encoder 1108 for mapping the image information 1102 into image embeddings, a text encoder 1110 for mapping the text information 1104 into text embeddings, and a video encoder 1112 for mapping the video segment information 1106 into action embeddings. A combining component 1114 combines the different kinds of embeddings together, e.g., by concatenating the embeddings. A language model 1116 maps the combined embeddings into a response. In some examples, the response is a function call that specifies a search condition. The matching component 820 applies the search condition to interrogate the spatiotemporal data structure.

Consider the following example. Assume that the input query submitted to the search system 130 specifies: “When did I last meet the person shown in this video <video>,” where “<video>” is a reference to an accompanying video. The encoders (1108, 1110, 1112) produce different kinds of embeddings based on the text of the query and the contents of the video. The language model 1116 maps this information into a function call that specifies a search condition that is formulated to interrogate the spatiotemporal data structure. The search condition includes information that conveys what task is being requested together with one or more embeddings that represent the person in the video who is the focus of the inquiry. The matching component 820 responds to this function call by retrieving at the information being sought—here, information regarding the identity of the person shown in the video.

In other implementations, the language model 1116 and matching component 820 work in cooperation in plural stages of inquiry. For example, assume that, in a first pass, the language model 1116 instructs the matching component 820 to retrieve information from the spatiotemporal data structure. In a second pass, the language model 1116 interprets the information that is retrieved, upon which it generates a response to the user or another instruction to the matching component 820 to retrieve additional information.

With the above introduction, the remainder of this section provides further details regarding one implementation of the multimodal language model 516. In some implementations, the image encoder 1108 partitions each input image into patches, to produce a partitioned image. For example, each patch includes a group of w×h pixels. The image encoder 1108 converts the patches into input vectors (e.g., via machine-trained linear projection), and supplements the input vectors with position information. Each position identifies the position of a patch in the input image. In some examples, the image encoder 1108 then maps the position-supplemented input vectors into image embeddings using a convolutional neural network or a transformer model or some other neural network. An example of a transformer-based visual encoder is described in Dosovitskiy, et al. al., “An Image is Worth 16×16 Words: Transformers for Image Recognition at Scale,” arXiv, arXiv:2010.11929v2 [cs.CV], Jun. 3, 2021, 22 pages.

The text encoder 1110 first tokenizes the text information 1104 into a series of text tokens. Each text token is a unit of text having any granularity, such as an individual word, a word fragment produced by byte pair encoding (BPE), a character n-gram, a word fragment identified by the WordPiece or SentencePiece algorithm, etc. The text encoder 1110 then maps IDs associated with the sequence of text tokens into respective input vectors, e.g., using a machine-trained linear projection. The text encoder 1110 then adds position information (and, in some cases, segment information) to the respective input vectors, to produce position-supplemented input vectors. A position-supplemented input vector describes the position of an associated text token in the input sequence of text tokens. In some examples, the text encoder 1110 then maps the position-supplemented input vectors into text embeddings using any type of neural network, such as a transformer model.

The video encoder 1112 is configured to produce a plurality of frames associated with a video segment. In some implementation, the video encoder 1112 first partitions each frame into two-dimensional w×h patches in the same manner described above for the image encoder 1108. In other examples, the video encoder 1112 partitions the frames into three-dimensional t×w×h sized patches (referred to as tubelets) that encompass image content from plural frames. In other examples, the video encoder 1112 generates video embeddings associated with respective whole frames (without further partitioning the frames). In whatever manner the video segment is partitioned, the video encoder 1112 converts the identified parts into input vectors, and adds position information to the input vectors to produce position-supplemented input vectors. The video encoder 1112 then uses any type of neural network (e.g., a convolutional neural network or a transformer neural network) to map the position-supplemental input vectors into action embeddings.

In the course of processing the position-supplemented input vectors using a transformer neural network, the video encoder 1112 performs attention analysis that involves computing intraframe relationships and interframe relationships. Intraframe relationships define relevance between patches of any given frame, while interframe relationships define relevance between patches in different frames. In some configurations, some layers of a transformer neural network are devoted to determining intraframe relationships, while other layers of the transformer neural network are devoted to determining interframe relationships. General background on the topic of transformer-based video processing can be found in Selva, et al., “Video Transformers: A Survey,” arXiv, arXiv:2201.05991v3 [cs.CV], Feb. 13, 2023, 26 pages.

In some implementations, the image encoder 1108, the text encoder 1110, and video encoder 1112 are trained to produce embeddings in a shared vector space. As a result of this training, the encoders (1108, 1110, 1112) will map instances of input information that describe similar concepts to embeddings that are close to each other in vector space, and instances of input information that describe dissimilar concepts to embeddings that are farther apart in the vector space. One distance metric for assessing the distance between vectors is cosine similarity. General background information on producing shared-space embeddings is provided in Radford, et al., “Learning Transferable Visual Models From Natural Language Supervision,” Proceedings of the 38th International Conference on Machine Learning, PMLR 139, 2021, 16 pages.

As described above, the combining component 1114 combines (e.g., concatenates) the image embeddings, text embeddings, and video embeddings into a combined instance of embeddings. The language model 1116 auto-regressively maps the combined embeddings into a response. Auto-regressive means that tokens are produced token by token, in which each new token that is generated is added to the sequence of input tokens passed to the language model 1116 in a next pass. This process continues until the language model 1116 generates a stop token. Other implementations of the language model 1116 are configured to perform a classification task in a single pass.

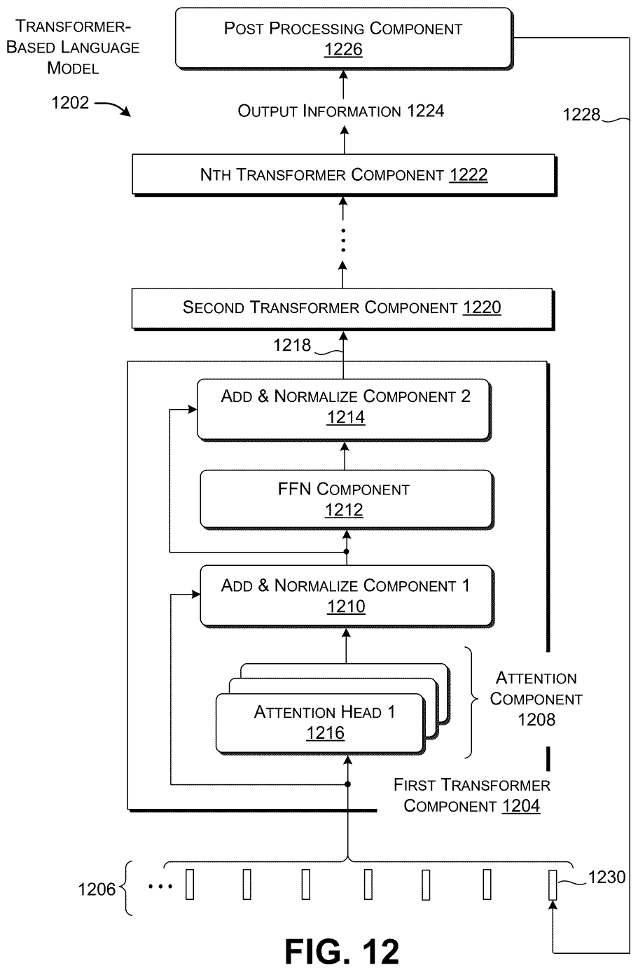

FIG. 12 shows a transformer-based language model (“language model”) 1202 for implementing any of the language model functions described above. The language model 1202 is composed, in part, of a pipeline of transformer components, including a first transformer component 1204. FIG. 12 provides details regarding one way to implement the first transformer component 1204. Although not specifically illustrated, other transformer components of the language model 1202 have the same architecture and perform the same functions as the first transformer component 1204 (but are governed by separate sets of weights).

The language model 1202 commences its operation with the receipt of the combined embeddings 1206 provided by the combining component 1114. The first transformer component 1204 operates on the combined embeddings 1206. In some implementations, the first transformer component 1204 includes, in order, an attention component 1208, a first add-and-normalize component 1210, a feed-forward neural network (FFN) component 1212, and a second add-and-normalize component 1214.

The attention component 1208 determines how much emphasis should be placed on parts of input information when interpreting other parts of the input information. Consider, for example, a sentence that reads: “I asked the professor a question, but he could not answer it.” When interpreting the word “it,” the attention component 1208 will determine how much weight or emphasis should be placed on each of the words of the sentence. The attention component 1208 will find that the word “question” is most significant.

The attention component 1208 performs attention analysis using the following equation:

$$Attention ( Q , K , V ) = soft max ( \frac{{QK}^{T}}{\sqrt{{d}_{k}}} ) V . \qquad ( 1 )$$

The attention component 1208 produces query information Q by generating the product of the combined embeddings 1206 and a query weighting matrix W^{Q}. Similarly, the attention component 1208 produces key information K and value information V by generating the product of the combined embeddings 1206 and a key weighting matrix W^{K} and a value weighting matrix W^{V}, respectively. To execute Equation (1), the attention component 1208 takes the dot product of Q with the transpose of K, and then divides the dot product by a scaling factor \sqrt{d}, to produce a scaled result. The symbol d represents the dimensionality of Q and K. The attention component 1208 takes the Softmax (normalized exponential function) of the scaled result, and then multiplies the result of the Softmax operation by V, to produce attention output information. In some cases, the attention component 1208 is said to perform masked attention insofar as the attention component 1208 masks output token information that, at any given time, has not yet been determined. Background information regarding the general concept of attention is provided in Vaswani, et al., “Attention Is All You Need,” in 31st Conference on Neural Information Processing Systems (NIPS 2017), 2017, 11 pages.

Note that FIG. 12 shows that the attention component 1208 is composed of plural attention heads, including a representative attention head 1216. Each attention head performs the computations specified by Equation (1), but with respect to a particular representational subspace that is different than the subspaces of the other attention heads. To accomplish this operation, the attention heads perform the computations described above using different respective sets of query, key, and value weight matrices. Although not shown, the attention component 1208 concatenates the output results of the attention component's separate attention heads, and then multiplies the results of this concatenation by another weight matrix W^{O}.

The add-and-normalize component 1210 includes a residual connection that combines (e.g., sums) input information fed to the attention component 1208 with the output information generated by the attention component 1208. The add-and-normalize component 1210 then normalizes the output information generated by the residual connection, e.g., by layer-normalizing values in the output information based on the mean and standard deviation of those values, or by performing root-mean-squared normalization. The other add-and-normalize component 1214 performs the same functions as the first-mentioned add-and-normalize component 1210. The FFN component 1212 transforms input information to output information using a feed-forward neural network having any number of layers.

The first transformer component 1204 produces output information 1218. A series of other transformer components (1220, . . . , 1222) perform the same functions as the first transformer component 1204, each operating on output information produced by its immediately preceding transformer component. Each transformer component uses its own level-specific set of machine-trained weights. The final transformer component 1222 in the language model 1202 produces final output information 1224.

In some implementations, a post-processing component 1226 performs post-processing operations on the final output information 1224. For example, the post-processing component 1226 performs a machine-trained linear transformation on the final output information 1224, and processes the results of this transformation using a Softmax component (not shown). The language model 1202 uses the output of the post-processing component 1226 to predict the next token in the input sequence of tokens. In some applications, the language model 1202 performs this task using a greedy selection approach (e.g., by selecting the token having the highest probability), or by using the beam search algorithm (e.g., by traversing a tree that expresses a search space of candidate next tokens).

In some implementations, the language model 1202 operates in an auto-regressive manner, as indicated by the loop 1228. To operate in this way, the language model 1202 appends a predicted token to the end of the sequence of input tokens, to provide an updated sequence of tokens. The predicted token leads to the production of a new embedding 1230. In a next pass, the language model 1202 processes the updated sequence of combined embeddings to generate a next predicted token. The language model 1202 repeats the above process until it generates a specified stop token

The above-described implementation of the language model 1202 relies on a decoder-only architecture. Other implementations of the language model 1202 use an encoder-decoder transformer-based architecture. Here, a transformer-based decoder receives encoder output information produced by a transformer-based encoder, together with decoder input information.

In other implementations, the post-processing component 1226 represents a classification component that produces a classification result. In some implementations, the classification component is implemented by using a fully connected feed-forward neural network having one or more layers followed by a Softmax component. A BERT-based transformer model is an example of this configuration.

Other implementations of the semantic-mapping component 122 use other kinds of machine-trained models instead of the language model 1202 described above or in addition to the language model 1202. These other machine-trained models include multilayer perceptrons (MLP), convolutional neural networks (CNNs), recurrent neural networks (RNNs), diffusion models, etc.

### E. Illustrative Processes

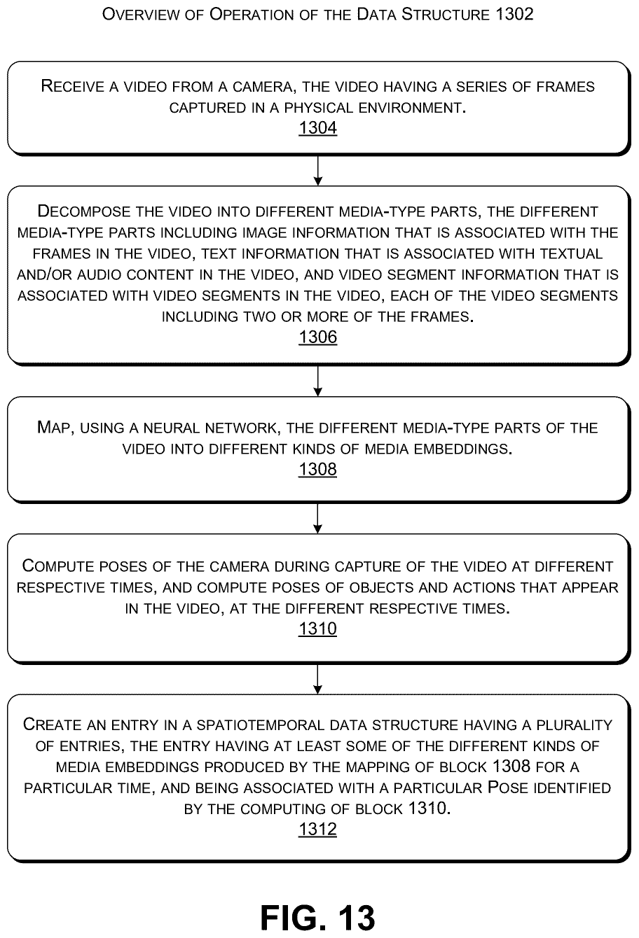

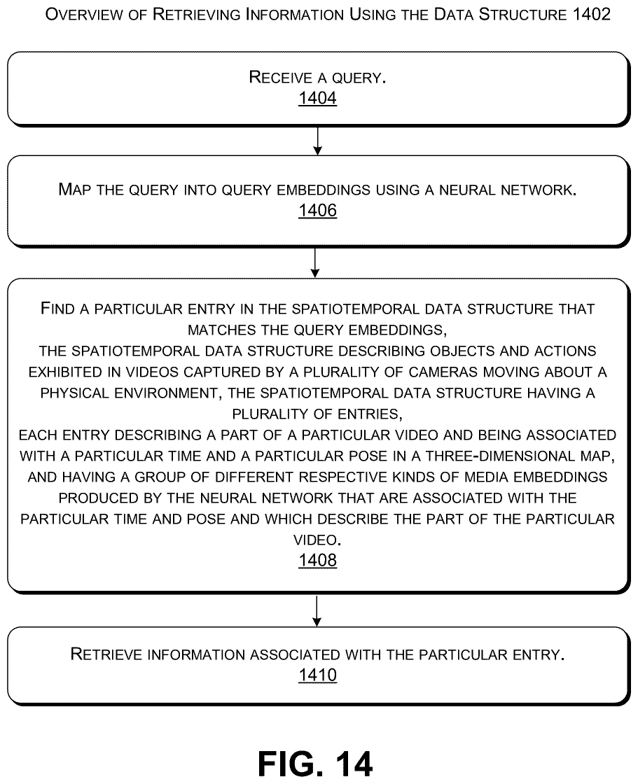

FIGS. 13 and 14 show two processes that represent an overview of the operation of the video-processing system 102 described in the previous sections. Each of the processes is expressed as a series of operations performed in a particular order. But the order of these operations is merely representative, and the operations are capable of being varied in other implementations. Further, any two or more operations described below are capable of being performed in a parallel manner. In one implementation, the blocks shown in the processes that pertain to processing-related functions are implemented by the computing equipment described in connection with FIGS. 15 and 16.

More specifically, FIG. 13 shows a process 1302 for creating an entry in a spatiotemporal data structure (e.g., the spatiotemporal data structure 302 or 402). In block 1304, the video-processing system 102 receives a video from a camera, the video having a series of frames captured in a physical environment. In block 1306, the video-processing system 102 decomposes the video into different media-type parts, including image information that is associated with the frames in the video, text information that is associated with textual and/or audio content in the video, and video segment information that is associated with video segments in the video (in which each of the video segments includes two or more of the frames). In block 1308, the video-processing system 102 maps, using a neural network, the different media-type parts of the video into different kinds of media embeddings. In block 1310, the video-processing system 102 computes poses of the camera during its capture of the video at different respective times. The video-processing system 102 also computes poses of objects and actions that appear in the video, at the different respective times. In block 1312, the video-processing system 102 creates an entry in a spatiotemporal data structure having a plurality of entries. The entry has at least some of the different kinds of media embeddings produced by the mapping of block 1308 for a particular time, and being associated with a particular pose identified by the computing of block 1310.

FIG. 14 shows a process 1402 for retrieving information from the spatiotemporal map. In block 1404, the video-processing system 102 receives a query. In block 1406, the video-processing system 102 maps the query into query embeddings using a neural network (e.g., the multimodal language model 516). In block 1408, the video-processing system 102 finds a particular entry in a spatiotemporal data structure (e.g., the spatiotemporal data structure 302 or 402) that matches the query embeddings. The spatiotemporal data structure describes objects and actions exhibited in videos captured by a plurality of cameras moving about a physical environment. More specifically, the spatiotemporal data structure has a plurality of entries. Each entry describes a part of a particular video and is associated with a particular time and a particular pose in a three-dimensional map. Each entry further has a group of different respective kinds of media embeddings produced by the neural network that are associated with the particular time and pose, and which describe the part of the particular video. In block 1410, the video-processing system 102 retrieves information associated with the particular entry.

### F. Illustrative Computing Systems

FIG. 15 shows computing equipment 1502 that, in some implementations, is used to implement video-processing system 102 of FIG. 1. The computing equipment 1502 includes a set of local devices 1504 coupled to a set of servers 1506 via a computer network 1508. Each local device corresponds to any type of computing device, including any of a desktop computing device, a laptop computing device, a handheld computing device of any type (e.g., a smartphone or a tablet-type computing device), an extended reality device, an intelligent appliance, a wearable computing device (e.g., a smart watch), an Internet-of-Things (IoT) device, a gaming system, an immersive “cave,” a media device, a vehicle-borne computing system, any type of robot computing system, a computing system in a manufacturing system, etc. In some implementations, the computer network 1508 is implemented as a local area network, a wide area network (e.g., the Internet), one or more point-to-point links, or any combination thereof.

The bottom-most overlapping box in FIG. 15 indicates that the functionality of the video-processing system 102 is capable of being spread across the local devices 1504 and/or the servers 1506 in any manner. In one example, the aspects for the video-processing system 102 that are responsible for creating the spatiotemporal data structure are implemented by the servers 1506. Further, the spatiotemporal data structure itself is stored on the servers 1506. The aspects of the video-processing system 102 that are responsible for capturing videos, receiving queries, and presenting output results are implemented by each local device. More generally, any function attributed above to the servers 1506 is capable of being performed by a local device, and vice versa.

FIG. 16 shows a computing system 1602 that, in some implementations, is used to implement any aspect of the mechanisms set forth in the above-described figures. For instance, in some implementations, the type of computing system 1602 shown in FIG. 16 is used to implement any local computing device or any server shown in FIG. 15. In all cases, the computing system 1602 represents a physical and tangible processing mechanism.

The computing system 1602 includes a processing system 1604 including one or more processors. The processor(s) include one or more central processing units (CPUs), and/or one or more graphics processing units (GPUs), and/or one or more application specific integrated circuits (ASICs), and/or one or more neural processing units (NPUs), and/or one or more tensor processing units (TPUs), etc. More generally, any processor corresponds to a general-purpose processing unit or an application-specific processor unit.

The computing system 1602 also includes computer-readable storage media 1606, corresponding to one or more computer-readable media hardware units. The computer-readable storage media 1606 retains any kind of information 1608, such as machine-readable instructions, settings, model weights, and/or other data. In some implementations, the computer-readable storage media 1606 includes one or more solid-state devices, one or more hard disks, one or more optical disks, etc. Any instance of the computer-readable storage media 1606 represents a fixed or removable unit of the computing system 1602. Further, any instance of the computer-readable storage media 1606 provides volatile and/or non-volatile retention of information. The specific term “computer-readable storage medium” or “storage device” expressly excludes propagated signals per se in transit; a computer-readable storage medium or storage device is “non-transitory” in this regard.

The computing system 1602 utilizes any instance of the computer-readable storage media 1606 in different ways. For example, in some implementations, any instance of the computer-readable storage media 1606 represents a hardware memory unit (such as random access memory (RAM)) for storing information during execution of a program by the computing system 1602, and/or a hardware storage unit (such as a hard disk) for retaining/archiving information on a more permanent basis. In the latter case, the computing system 1602 also includes one or more drive mechanisms 1610 (such as a hard drive mechanism) for storing and retrieving information from an instance of the computer-readable storage media 1606.

In some implementations, the computing system 1602 performs any of the functions described above when the processing system 1604 executes computer-readable instructions stored in any instance of the computer-readable storage media 1606. For instance, in some implementations, the computing system 1602 carries out computer-readable instructions to perform each block of the processes described with reference to FIGS. 13 and 14. FIG. 16 generally indicates that hardware logic circuitry 1612 includes any combination of the processing system 1604 and the computer-readable storage media 1606.

In addition, or alternatively, the processing system 1604 includes one or more other configurable logic units that perform operations using a collection of logic gates, such as field-programmable gate arrays (FPGAs), etc. In these implementations, the processing system 1604 effectively incorporates a storage device that stores computer-readable instructions, insofar as the configurable logic units are configured to execute the instructions and therefore embody or store these instructions.

In some cases (e.g., in the case in which the computing system 1602 represents a user computing device), the computing system 1602 also includes an input/output interface 1614 for receiving various inputs (via input devices 1616), and for providing various outputs (via output devices 1618). Illustrative input devices include a keyboard device, a mouse input device, a touchscreen input device, a digitizing pad, one or more static image cameras, one or more video cameras, one or more depth camera systems, one or more microphones, a voice recognition mechanism, any position-determining devices (e.g., GPS devices), any movement detection mechanisms (e.g., accelerometers and/or gyroscopes), etc. In some implementations, one particular output mechanism includes a display device 1620 and an associated graphical user interface presentation (GUI) 1622. The display device 1620 corresponds to a liquid crystal display device, a light-emitting diode display (LED) device, a cathode ray tube device, a projection mechanism, etc. Other output devices include a printer, one or more speakers, a haptic output mechanism, an archival mechanism (for storing output information), etc. In some implementations, the computing system 1602 also includes one or more network interfaces 1624 for exchanging data with other devices via one or more communication conduits 1626. One or more communication buses 1628 communicatively couple the above-described units together.

The communication conduit(s) 1626 is implemented in any manner, e.g., by a local area computer network, a wide area computer network (e.g., the Internet), point-to-point connections, or any combination thereof. The communication conduit(s) 1626 include any combination of hardwired links, wireless links, routers, gateway functionality, name servers, etc., governed by any protocol or combination of protocols.

FIG. 16 shows the computing system 1602 as being composed of a discrete collection of separate units. In some cases, the collection of units corresponds to discrete hardware units provided in a computing device chassis having any form factor. FIG. 16 shows illustrative form factors in its bottom portion. In other cases, the computing system 1602 includes a hardware logic unit that integrates the functions of two or more of the units shown in FIG. 16. For instance, in some implementations, the computing system 1602 includes a system on a chip (SoC or SOC), corresponding to an integrated circuit that combines the functions of two or more of the units shown in FIG. 16.

The following summary provides a set of illustrative examples of the technology set forth herein.
(A1) According to one aspect, a method (e.g., the process 1302) is described for processing a video. The method includes: receiving (e.g., in block 1304) the video from a camera, the video having a series of frames captured in a physical environment; decomposing (e.g., in block 1306) the video into different media-type parts, the different media-type parts including image information that is associated with the frames in the video, text information that is associated with textual and/or audio content in the video, and video segment information that is associated with video segments in the video, each of the video segments including two or more of the frames; mapping (e.g., in block 1308), using a neural network (e.g., the multimodal language model 516), the different media-type parts of the video into different kinds of media embeddings; computing (e.g., block 1310) poses of the camera during capture of the video at different respective times, and computing poses of objects and actions that appear in the video, at the different respective times; and creating (e.g., in block 1312) an entry in a spatiotemporal data structure having a plurality of entries, the entry having at least some of the different kinds of media embeddings produced by the mapping for a particular time, and being associated with a particular pose identified by the computing.
(A2) According to some implementations of the method of A1, the mapping includes: mapping the image information into image embeddings that describe objects and events that appear in the frames; mapping the text information into text embeddings that describe the textual and/or audio content of the video; and mapping the video segment information into action embeddings that describe actions exhibited by the video segments of the video. The image embeddings, text embeddings, and action embeddings are the different kinds of media embeddings.
(A3) According to some implementations of the method of A1 or A2, the neural network is a multimodal vision language model.
(A4) According to some implementations of any of the methods of A1-A3, the computing is performed by a simultaneous localization and mapping algorithm.
(A5) According to some implementations of any of the methods of A1-A3, the entries in the spatiotemporal data structure describe plural videos captured by plural cameras that traverse the physical environment.
(A6) According to some implementations of the method of A5, other entries in the spatiotemporal data structure describe videos captured by stationary cameras placed in the physical environment.
(A7) According to some implementations of any of the methods of A1-A6, the method further includes: generating a status label for the entry, the status label identifying whether the entry is associated with private content or shared content; and storing the entry in a first spatiotemporal data structure for a status label that indicates that the entry is associated with private content, and storing the entry in a second spatiotemporal data structure for a status label that indicates that the entry is associated with shared content, the first spatiotemporal data structure being accessible to a smaller group of users compared to the second spatiotemporal data structure.
(A8) According to some implementations of any of the methods of A1-A7, the method further including searching the spatiotemporal data structure by: receiving a query, the query including any combination of textual content, image content, and/or video content; mapping the query into query embeddings using the neural network; finding a particular entry in the spatiotemporal data structure that matches the query embeddings; and retrieving information associated with the particular entry.
(A9) According to some implementations of the method of A8, the query expresses an intent to retrieve information about a prior activity captured by at least one video and described in the spatiotemporal data structure.
(A10) According to some implementations of the method of A8, the query expresses an intent to retrieve information about an object captured by at least one video and described in the spatiotemporal data structure.
(A11) According to some implementations of any of the methods of A1-A10, the method further includes: receiving a setting that expresses a triggering condition; storing information regarding the triggering condition; receiving another video; mapping the other video into other-video embeddings using the neural network; and generating a notification upon detecting that the other-video embeddings match the information regarding the triggering condition.
(A12) According to some implementations of any of the methods of A1-A11, the method further includes controlling movement of an autonomous agent based on the spatiotemporal data structure.
(A13) According to some implementations of any of the methods of A1-A12, the method further includes generating, by an extended reality system, a representation of the physical environment, annotated with information regarding activities and/or objects observed in at least one video based on the spatiotemporal data structure.
(B1) According to another aspect, a method (e.g., the process 1402) is described for retrieving information. The method relies on a data store for storing a spatiotemporal data structure that describes objects and actions exhibited in videos captured by a plurality of cameras moving about a physical environment, the spatiotemporal data structure having a plurality of entries. Each entry describes a part of a particular video that is associated with a particular time and a particular pose in a three-dimensional map, and having a group of different respective kinds of media embeddings produced by a neural network (e.g., the multimodal language model 516) that are associated with the particular time and pose. The group of different kinds of media embeddings describes the part of the particular video. The method includes: receiving (e.g., in block 1404) a query; mapping (e.g., in block 1406) the query into query embeddings using the neural network; finding (e.g., in block 1408) a particular entry in the spatiotemporal data structure that matches the query embeddings; and retrieving (e.g., in block 1410) information associated with the particular entry.

In yet another aspect, some implementations of the technology described herein include a computing system (e.g., the computing system 1602) that includes a processing system (e.g., the processing system 1604) having a processor. The computing system also includes a storage device (e.g., the computer-readable storage media 1606) for storing computer-readable instructions (e.g., the information 1608). The processing system executes the computer-readable instructions to perform any of the methods described herein (e.g., any individual method of the methods of A1-A13 and B1).

In yet another aspect, some implementations of the technology described herein include a computer-readable storage medium (e.g., the computer-readable storage media 1606) for storing computer-readable instructions (e.g., the information 1608). A processing system (e.g., the processing system 1604) executes the computer-readable instructions to perform any of the operations described herein (e.g., the operations in any individual method of the methods of A1-A13 and B1).

More generally stated, any of the individual elements and steps described herein are combinable into any logically consistent permutation or subset. Further, any such combination is capable of being manifested as a method, device, system, computer-readable storage medium, data structure, article of manufacture, graphical user interface presentation, etc. The technology is also expressible as a series of means-plus-format elements in the claims, although this format should not be considered to be invoked unless the phrase “means for” is explicitly used in the claims.

This description may have identified one or more features as optional. This type of statement is not to be interpreted as an exhaustive indication of features that are to be considered optional; generally, any feature is to be considered as an example, although not explicitly identified in the text, unless otherwise noted. Further, any features described as alternative ways of carrying out identified functions or implementing identified mechanisms are also combinable together in any combination, unless otherwise noted.

In terms of specific terminology, the phrase “configured to” encompasses various physical and tangible mechanisms for performing an identified operation. The mechanisms are configurable to perform an operation using the hardware logic circuitry 1612 of FIG. 16. The term “logic” likewise encompasses various physical and tangible mechanisms for performing a task. For instance, each processing-related operation illustrated in the flowcharts of FIGS. 19 and 20 corresponds to a logic component for performing that operation.

Further, the term “plurality” or “plural” or the plural form of any term (without explicit use of “plurality” or “plural”) refers to two or more items, and does not necessarily imply “all” items of a particular kind, unless otherwise explicitly specified. The term “at least one of” refers to one or more items; reference to a single item, without explicit recitation of “at least one of” or the like, is not intended to preclude the inclusion of plural items, unless otherwise noted. Further, the descriptors “first,” “second,” “third,” etc. are used to distinguish among different items, and do not imply an ordering among items, unless otherwise noted. The phrase “A and/or B” means A, or B, or A and B. The phrase “any combination thereof” refers to any combination of two or more elements in a list of elements. Further, the terms “comprising,” “including,” and “having” are open-ended terms that are used to identify at least one part of a larger whole, but not necessarily all parts of the whole. A “set” is a group that includes one or more members. The phrase “A corresponds to B” means “A is B” in some contexts. The term “prescribed” is used to designate that something is purposely chosen according to any environment-specific considerations. For instance, a threshold value or state is said to be prescribed insofar as it is purposely chosen to achieve a desired result. “Environment-specific” means that a state is chosen for use in a particular environment. Finally, the terms “exemplary” or “illustrative” refer to one implementation among potentially many implementations.

In closing, the description may have set forth various concepts in the context of illustrative challenges or problems. This manner of explanation is not intended to suggest that others have appreciated and/or articulated the challenges or problems in the manner specified herein. Further, this manner of explanation is not intended to suggest that the subject matter recited in the claims is limited to solving the identified challenges or problems; that is, the subject matter in the claims may be applied in the context of challenges or problems other than those described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for processing a video, comprising:
receiving the video from a camera, the video having a series of frames captured in a physical environment;
decomposing the video into different media-type parts, the different media-type parts including image information that is associated with the frames in the video, text information that is associated with textual and/or audio content in the video, and video segment information that is associated with video segments in the video, each of the video segments including two or more of the frames;
mapping, using a neural network, the different media-type parts of the video into different kinds of media embeddings;
computing poses of the camera during capture of the video at different respective times, and computing poses of objects and actions that appear in the video, at the different respective times; and
creating an entry in a spatiotemporal data structure having a plurality of entries, the entry having at least some of the different kinds of media embeddings produced by said mapping for a particular time, and being associated with a particular pose identified by said computing.

2. The method of claim 1, wherein the mapping includes:
mapping the image information into image embeddings that describe objects and events that appear in the frames;
mapping the text information into text embeddings that describe the textual and/or audio content of the video; and
mapping the video segment information into action embeddings that describe actions exhibited by the video segments of the video,
the image embeddings, text embeddings, and action embeddings being the different kinds of media embeddings.

3. The method of claim 1, wherein the neural network is a multimodal vision language model.

4. The method of claim 1, wherein said computing is performed by a simultaneous localization and mapping algorithm.

5. The method of claim 1, wherein the entries in the spatiotemporal data structure describe plural videos captured by plural cameras that traverse the physical environment.

6. The method of claim 5, wherein other entries in the spatiotemporal data structure describe videos captured by stationary cameras placed in the physical environment.

7. The method of claim 1, further including:
generating a status label for the entry, the status label identifying whether the entry is associated with private content or shared content; and
storing the entry in a first spatiotemporal data structure for a status label that indicates that the entry is associated with private content, and storing the entry in a second spatiotemporal data structure for a status label that indicates that the entry is associated with shared content,
the first spatiotemporal data structure being accessible to a smaller group of users compared to the second spatiotemporal data structure.

8. The method of claim 1, further comprising searching the spatiotemporal data structure by:
receiving a query, the query including any combination of textual content, image content, and/or video content;
mapping the query into query embeddings using the neural network;
finding a particular entry in the spatiotemporal data structure that matches the query embeddings; and
retrieving information associated with the particular entry.

9. The method of claim 8, wherein the query expresses an intent to retrieve information about a prior activity captured by at least one video and described in the spatiotemporal data structure.

10. The method of claim 8, wherein the query expresses an intent to retrieve information about an object captured by at least one video and described in the spatiotemporal data structure.

11. The method of claim 1, further comprising:
receiving a setting that expresses a triggering condition;
storing information regarding the triggering condition;
receiving another video;
mapping said another video into other-video embeddings using the neural network; and
generating a notification upon detecting that the other-video embeddings match the information regarding the triggering condition.

12. The method of claim 1, further comprising controlling movement of an autonomous agent based on the spatiotemporal data structure.

13. The method of claim 1, further including generating, by an extended reality system, a representation of the physical environment, annotated with information regarding activities and/or objects observed in at least one video based on the spatiotemporal data structure.

14. A computing system for retrieving information, comprising:
an instruction data store for storing computer-readable instructions;
a data store for storing a spatiotemporal data structure that describes objects and actions exhibited in videos captured by a plurality of cameras moving about a physical environment, the spatiotemporal data structure having a plurality of entries,
each entry describing a part of a particular video and being associated with a particular time and a particular pose in a three-dimensional map, and having a group of different respective kinds of media embeddings produced by a neural network that are associated with the particular time and pose,
the group of different kinds of media embeddings describing said part of the particular video,
a processing system for executing the computer-readable instructions in the data store, to perform operations including:
receiving a query;
mapping the query into query embeddings using the neural network;
finding a particular entry in the spatiotemporal data structure that matches the query embeddings; and
retrieving information associated with the particular entry.

15. The computing system of claim 14, wherein the group of different kinds of media embeddings are produced by:
mapping image information that describes objects and events that appear in frames of the particular video into image embeddings;
mapping text information that describes textual and/or audio content of the particular video into text embeddings; and
mapping video segment information that describes video segments of the particular video into action embeddings, each of the video segments including two or more of the frames.

16. The computing system of claim 14, wherein the query expresses an intent to retrieve information about a prior activity described in the spatiotemporal data structure.

17. The computing system of claim 14, wherein the operations further comprise:
receiving a setting that expresses a triggering condition;
storing information regarding the triggering condition;
receiving another video;
mapping said another video into other-video embeddings using the neural network; and
generating a notification upon detecting that the other-video embeddings match the information regarding the triggering condition.

18. A computer-readable storage medium for storing computer-readable instructions, a processing system executing the computer-readable instructions to perform operations, the operations comprising:
receiving plural videos captured by plural cameras in a physical environment;
creating entries in a spatiotemporal data structure that describes objects and activities in the videos,
each entry in the spatiotemporal data structure being created by:
mapping, using a neural network, image information that describes objects and events that appear in frames of a particular video into image embeddings;
mapping, using the neural network, text information that describes textual and/or audio content of the particular video into text embeddings;
mapping, using the neural network, video segment information that describes actions exhibited by video segments of the particular video into action embeddings, each of the video segments including two or more of the frames;
computing poses of the camera during capture of the particular video at different respective times, and computing poses of the objects and actions that appear in the particular video, at the different respective times; and
storing a group of the different respective kinds of media embeddings in the entry of the spatiotemporal data structure,
the group being associated with a particular pose identified by said computing and a particular time.

19. The computer-readable storage medium of claim 18, wherein the operations further include querying the spatiotemporal data structure to retrieve information regarding an object or activity observed by at least one of the plural cameras.

20. The computer-readable storage medium of claim 19, wherein the querying comprises:
receiving a query;
mapping the query into query embeddings using the neural network;
finding a particular entry in the spatiotemporal data structure that matches the query embeddings; and
retrieving information associated with the particular entry.
